(19) United States
(12) Patent Application Publication
(10) Pub. No.: US 2024/0276899 A1
(43) Pub. Date: Aug. 22, 2024

(54) SOIL FINISHER ASSEMBLY FOR AN AGRICULTURAL IMPLEMENT

(71) Applicant: CNH Industrial America LLC, New Holland, PA (US)

(72) Inventor: Michael George Kovach, Morton, IL (US)

(21) Appl. No.: 18/110,713

(22) Filed: Feb. 16, 2023

(51) Int. Cl. A01B 33/02; A01B 21/08

(52) U.S. Cl. CPC A01B 33/024; A01B 21/08

(57) ABSTRACT

A tilling implement includes a frame, a row of disc blades coupled to the frame, and a soil finisher coupled to the frame. The soil finisher includes multiple chopper blades, each chopper blade of the multiple chopper blades includes multiple fins that extend radially from a hub, a first set of the multiple fins bend in a first direction relative to the hub, and a second set of the multiple fins bend in a second direction relative to the hub to facilitate tossing soil as the tilling implement travels through a field.

### BACKGROUND

The present disclosure relates generally to a soil finisher assembly for an agricultural implement. More particularly, the present disclosure relates to a soil finisher assembly with multiple choppers that are configured to smooth and/or level a surface of a field as the agricultural implement travels through the field.

This section is intended to introduce the reader to various aspects of art that may be related to various aspects of the present disclosure, and are described below. This discussion is believed to be helpful in providing the reader with background information to facilitate a better understanding of the various aspects of the present disclosure. Accordingly, it should be noted that these statements are to be read in this light, and not as admissions of prior art.

Agricultural systems are used to farm a field, and a particular agricultural system may include a work vehicle and an agricultural implement towed behind the work vehicle. The agricultural implement may include a tool or component that may engage the field as the agricultural implement is towed behind the work vehicle. In this way, the agricultural implement may perform a farming operation, such as tilling, planting, seeding, and so forth. For example, a tillage implement may perform tilling via disc blades that engage a field as the tillage implement is towed behind a tractor.

### SUMMARY

A summary of certain embodiments disclosed herein is set forth below. It should be noted that these aspects are presented merely to provide the reader with a brief summary of these certain embodiments and that these aspects are not intended to limit the scope of this disclosure. Indeed, this disclosure may encompass a variety of aspects that may not be set forth below

In certain embodiments, a tilling implement includes a frame, a row of disc blades coupled to the frame, and a soil finisher coupled to the frame. The soil finisher includes multiple chopper blades, each chopper blade of the multiple chopper blades includes multiple fins that extend radially from a hub, a first set of the multiple fins bend in a first direction relative to the hub, and a second set of the multiple fins bend in a second direction relative to the hub to facilitate tossing soil as the tilling implement travels through a field.

In certain embodiments, a soil finisher for a tilling implement includes a frame, a mounting bracket coupled to the frame, a shaft coupled to the mounting bracket, and multiple chopper blades disposed on the shaft. Each chopper blade of the multiple chopper blades includes a hub and multiple fins circumferentially disposed about the hub relative to a rotational axis of the hub, a first set of the multiple fins bend laterally in a first direction relative to the hub, and a second set of the multiple fins bend laterally in a second direction relative to the hub to facilitate tossing soil in the first direction and the second direction as the tilling implement travels through a field.

In certain embodiments, an agricultural system includes a work vehicle and a tilling implement configured to couple to the work vehicle. The tilling implement includes a frame, a row of disc blades coupled to the frame, and a soil finisher coupled to the frame rearward of the row of disc blades relative to a forward direction of travel of the agricultural system. The soil finisher includes multiple chopper blades and each chopper blade of the multiple chopper blades includes multiple fins that extend radially from a hub. Additionally, a first fin of the multiple fins bends in a first direction relative to the hub, and a second fin of the multiple fins bends in a second direction relative to the hub to facilitate tossing soil as the tilling implement travels through a field.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an agricultural system having a work vehicle and an agricultural implement, in accordance with an aspect of the present disclosure;

FIG. 2 is a perspective view of a portion of the agricultural implement of FIG. 1, including disc blades and chopper blades, in accordance with an aspect of the present disclosure;

FIG. 3 is a top view of a portion of the agricultural implement of FIG. 1, including the disc blades and the chopper blades, in accordance with an aspect of the present disclosure;

FIG. 4 is a perspective view of a portion of the agricultural implement of FIG. 1, with the disc blades removed to facilitate visualization of the chopper blades, in accordance with an aspect of the present disclosure;

FIG. 5 is a perspective view of a portion of the agricultural implement of FIG. 1, including the chopper blades, in accordance with an aspect of the present disclosure;

FIG. 6 is a perspective view of one of the chopper blades that may be used in the agricultural implement of FIG. 1, in accordance with an embodiment of the present disclosure;

FIG. 7 is a side view of one of the chopper blades that may be used in the agricultural implement of FIG. 1, in accordance with an embodiment of the present disclosure; and

FIG. 8 is a front view of one of the chopper blades that may be used in the agricultural implement of FIG. 1, in accordance with an embodiment of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

The present disclosure is generally directed to a soil finisher (e.g., rotatable reel assembly; rolling soil finisher) for an agricultural implement (e.g., tillage implement; ground working implement). The agricultural implement may include a frame and at least one row of disc blades (e.g., fluted concave disc blades) coupled to the frame adjacent a front of the frame (e.g., relative to a forward direction of travel). In certain embodiments, the soil finisher also includes at least one row of chopper blades located behind the at least one row of disc blades (e.g., relative to the forward direction of travel). Each chopper blade in the at least one row of chopper blades may include multiple fins (e.g., paddles) that are configured to break up soil and/or smooth the soil as the soil finisher travels through the field. For example, each chopper blade may break up the soil and toss the soil to create a smooth layer of the soil as the soil finisher travels through the field. While certain existing implements may include components that are designed to leave a rough (e.g., not smooth) surface of the soil, it is presently recognized that it may be desirable to provide a smooth surface of the soil, and also to provide the smooth surface of the soil via tossing the soil. Accordingly, the soil finisher described herein includes features that are designed to provide these operations and results. Advantageously, the agricultural implement with the soil finisher that includes the at least one row of chopper blades may enable even seed germination, strong root growth, and increased crop yield. Further, the soil finisher may have a lower weight than other reels (e.g., a rolling reel with laterally extending bars), which may facilitate operation of the agricultural system 10 and/or limit compaction of the soil as the soil finisher travels through the field.

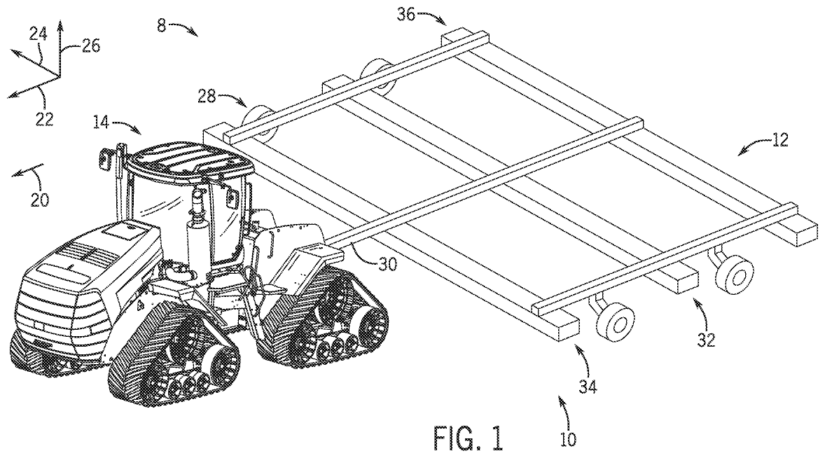

Referring now to the drawings, FIG. 1 is a partial perspective view of an agricultural system 8 with an agricultural implement 10 (e.g., tillage implement; ground working implement) having a soil finisher 12 (e.g., rotatable reel assembly; rolling soil finisher). The agricultural implement 10 may be towed by a work vehicle 14 (e.g., tractor) in a forward direction of travel 20. The agricultural implement 10 and its components may be described with reference to an axial axis or direction 22, a lateral axis or direction 24, and a vertical axis or direction 26. In FIG. 1, certain elements of the agricultural implement 10 are shown schematically to facilitate discussion.

The agricultural implement 10 includes a frame 28 (e.g., main frame) that includes a hitch assembly 30 that couples the agricultural implement 10 to the work vehicle 14. The frame 28 may support at least one row of disc blades and/or at least one row of chopper blades. As shown, the frame 28 supports a first row of disc blades 32 and a second row of disc blades 34, as well as a row of chopper blades 36. It should be appreciated that the frame 28 may include any of a variety of frame elements, such as laterally-extending toolbars and/or axially-extending support brackets, to support the at least one row of disc blades and/or the at least one row of chopper blades.

As depicted, the first row of disc blades 32 is located behind the second row of disc blades 34 relative to the forward direction of travel 20. Additionally, the row of chopper blades 36 is located behind the first row of disc blades 32 and the second row of disc blades 34 relative to the forward direction of travel 20. Generally, it may be desirable to position at least one of the at least one row of chopper blades in a rear-most position of the agricultural implement 10 (e.g., rearward of all of the at least one row of disc blades and/or rearward of all other ground-engaging structures of the agricultural implement 10 relative to the forward direction of travel 20). However, it should be appreciated that variations in position are envisioned, and one or more of the at least one row of chopper blades may be located at various positions (e.g., various axial positions) relative to the at least one row of disc blades and/or other ground-engaging structures of the agricultural implement 10 relative to the forward direction of travel 20. For example, the row of chopper blades 36 may be forward of all of the at least one row of disc blades, between the first row of disc blades 32 and the second row of disc blades 34, and so forth. In some embodiments, the row of chopper blades 36 may be in the rear-most position of the agricultural implement 10, and at least one additional row of chopper blades may be positioned forward of the row of chopper blades 36 and/or forward of at least one of the at least one row of disc blades, and so forth. In such cases, the row of chopper blades 36 and the at least one additional row of chopper blades may include the same or different types and/or combinations of chopper blades (e.g., with multiple fins and compound angles; simple blades). For example, the row of chopper blades 36 in the rear-most position of the agricultural implement 10 may include the chopper blades with the multiple fins and compound angles, while the at least on additional row of chopper blades may include the chopper blades with the multiple fins and compound angles, or alternatively the simple blades. It should also be appreciated that the agricultural implement 10 may include a rolling reel, such as at any position forward and/or rearward of the row of chopper blades 36.

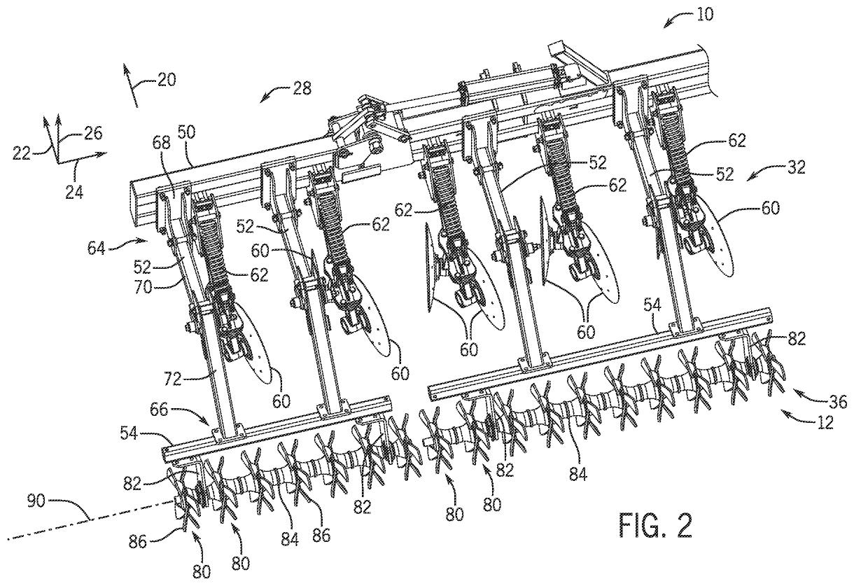

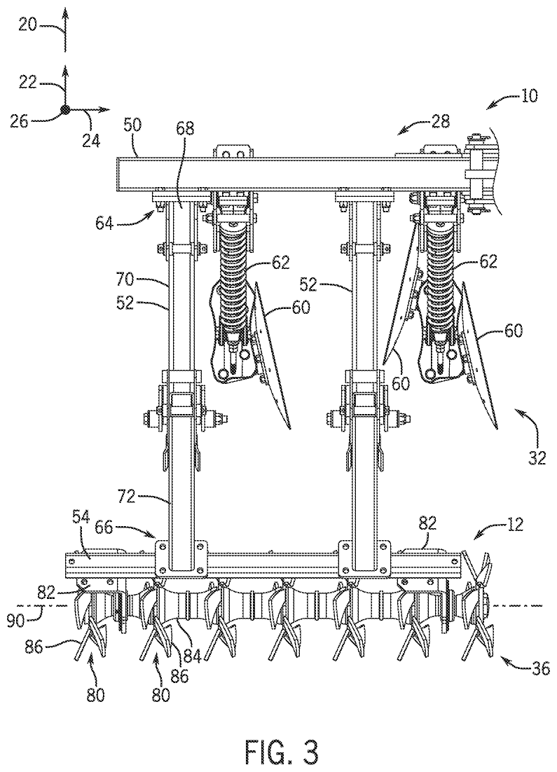

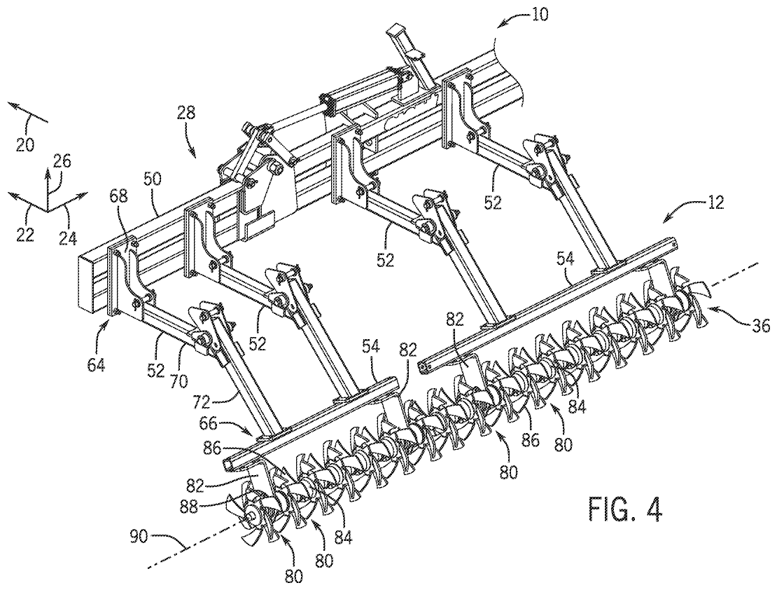

FIGS. 2 and 3 provide additional views of embodiments of portions of the agricultural implement 10 with the first row of disc blades 32 (also referred to herein as “the row of disc blades 32” to facilitate discussion) and the row of chopper blades 36. In particular, FIG. 2 is a perspective view of an embodiment of a portion of the agricultural implement 10 with the row of disc blades 32 and the row of chopper blades 36. Additionally, FIG. 3 is a top view of an embodiment of a portion of the agricultural implement 10 with the row of disc blades 32 and the row of chopper blades 36. Further, FIG. 4 is a perspective view of an embodiment of a portion of the agricultural implement 10 with the row of disc blades 32 removed to facilitate visualization of the row of chopper blades 36.

With reference to FIGS. 2-4, the agricultural implement 10 includes a toolbar 50, support brackets 52, and mounting bars 54. The toolbar 50, the support brackets 52 and the mounting bars 54 may be considered to be part of the frame 28 of the agricultural implement 10. As shown, the row of disc blades 32 includes pairs of disc blades 60 distributed (e.g., spaced apart) laterally across the agricultural implement 10. In some embodiments, a single disc blade 60 (e.g., not part of a pair) may be positioned at a lateral end of the row of disc blades 32. That is, each of the pairs of disc blades 60 and the single disc blade 60 may be supported on a respective disc blade support arm 62. The agricultural implement 10 may include any number of disc blades 60 in the row of disc blades 32 (e.g., 10, 20, or more). The disc blades 60 may be mounted with a camber to minimize blade to soil backpressure. In certain embodiments, an angle of attack (e.g., angle of blades relative to the forward direction of travel 20) of the disc blades 60 may be adjusted (e.g., via linkages). In certain embodiments, a down pressure applied by the row of disc blades 32 to soil and/or a position of the row of disc blades 32 relative to the toolbar 50 may be adjusted (e.g., via actuators and/or biasing members).

With reference to FIGS. 2-4, the agricultural implement 10 also includes the soil finisher 12 that includes the row of chopper blades 36. As shown, the support brackets 52 extend between the toolbar 50 and mounting bars 54. In particular, the support brackets 52 extend axially between the toolbar 50 and the mounting bars 54, with a first end 64 (e.g., end portion) coupled (e.g., rigidly coupled) to the toolbar 50 and a second end 66 (e.g., end portion) coupled (e.g., rigidly coupled) to the mounting bars 54. The support brackets 52 may include multiple portions that are coupled to one another, such as a bracket portion 68, a first arm portion 70, and a second arm portion 72 that are coupled to one another. In some embodiments, the bracket portion 68 is rigidly coupled to the toolbar 50, and the bracket portion 68, the first arm portion 70, and/or the second arm portion 72 are movably coupled (e.g., rotatably and/or slidingly coupled) to one another to allow adjustments to the the row of chopper blades 36. In certain embodiments, a down pressure applied by the row of chopper blades 36 to soil and/or a position of the row of disc blades 32 relative to the toolbar 50 may be adjusted (e.g., via the multiple portions; via actuators and/or biasing members). It should be appreciated that the support brackets 52 may have any suitable form, including one-piece construction, two-piece construction, any number of multiple portions coupled to one another, different arrangements of connections (e.g., joints, pivots, rigid connections), and so forth.

As shown, the row of chopper blades 36 may include multiple segments or sections of chopper blades 80 distributed (e.g., spaced apart) laterally across the agricultural implement 10. For example, each of the mounting bars 54 extends laterally across a respective portion of the agricultural implement 10 and supports a respective set of multiple chopper blades 80 that together form the row of chopper blades 36.

Further, each of the mounting bars 54 includes or is coupled (e.g., rigidly coupled) to one or more mounting brackets 82, and the one or more mounting brackets 82 are coupled (e.g., rigidly or rotatably coupled) to a shaft 84 (e.g., laterally-extending shaft; fixed position to extend along the lateral axis 24; orthogonal to the forward direction of travel 20). The chopper blades 80 are coupled (e.g., rigidly or rotatably coupled) to the shaft 84. In some embodiments, the chopper blades 80 may rigidly coupled to the shaft 84, such that the chopper blades 80 rotate with the shaft 84. In some embodiments, the chopper blades 80 may be rotatably coupled to the shaft 84, such that the chopper blades 80 individually rotate relative to the shaft 84. In any case, each of the chopper blades 80 is configured to rotate (e.g., roll) over and/or through the soil, as well as relative to the frame 28 (e.g., the toolbar 50, the support brackets 52, and/or the mounting bars 54), as the agricultural implement 10 travels through the field.

As shown, each of the chopper blades 80 includes multiple fins 86 coupled to and circumferentially disposed about a hub 88 (FIG. 4) relative to a rotational axis 90. As discussed in more detail herein, the multiple fins 86 are mounted or formed on the hub 88 at a compound angle with respect to the forward direction of travel 20. The compound angle enables the chopper blades 80 to lift and toss the soil as the agricultural implement 10 travels through the field.

As shown, the row of chopper blades 36 of the soil finisher 12 is located behind the row of disc blades 32 relative to the forward direction of travel 20. However, as discussed herein, the row of chopper blades 36 and/or one or more additional rows of chopper blades may be positioned at other locations of the agricultural implement 10. In some embodiments, the chopper blades 80 of the soil finisher 12 operate at a same soil depth (e.g., tillage depth) as the pairs of disc blades 60 on the row of disc blades 32.

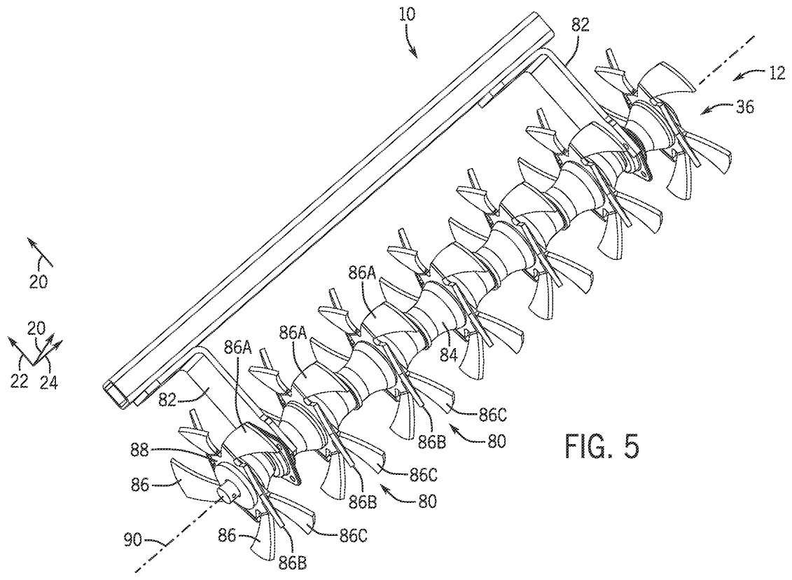

FIG. 5 is a perspective view of an embodiment of a portion of the agricultural implement 10 with one segment of the chopper blades 80 of the row of chopper blades 36 that form part of the soil finisher 12. In particular, FIG. 5 illustrates one of the mounting bars 54 coupled to the at least one mounting brackets 82, which are coupled to the shaft 84 and the chopper blades 80 of the row of chopper blades 36.

As shown, each of the chopper blades 80 includes the multiple fins 86 coupled to and circumferentially disposed about the hub 88 relative to the rotational axis 90. As discussed in more detail herein, the multiple fins 86 are mounted or formed on the hub 88 at a compound angle with respect to the forward direction of travel 20. In certain embodiments, each of the chopper blades 80 may have a same geometry (e.g., size and shape). For example, each of the chopper blades 80 may have a same diameter. However, in certain embodiments, at least one of the chopper blades 80 may have a different diameter (e.g., smaller diameter; simple blades without the fins 86) from other ones of the chopper blades 80. Indeed, a manufacturer may provide a kit of different types of blades, including the chopper blades 80 and one or more other types of blades (e.g., the simple blades), for selection by the operator of the agricultural implement 10 and/or for use in various combinations. Further, each of the chopper blades 80 may be aligned with one another relative to the shaft 84 (e.g., the multiple fins 86 of each of the chopper blades 80, at least along a particular one of the mounting bars 54, are circumferentially or rotationally aligned relative to the shaft 84; first fins 86A, second fins 86B, third fins 86C, and so forth are aligned relative to the shaft 84). However, in certain embodiments, at least one of the chopper blades 80 may rotationally offset (e.g., by 10, 15, 20, 25, 30, 35, 40, 45, or more degrees) relative to other ones of the chopper blades 80 relative to the shaft 84. Each of the chopper blades 80 may include any suitable number of fins 86, such as 3, 4, 5, 6, 7, 8, 9, 10, or more.

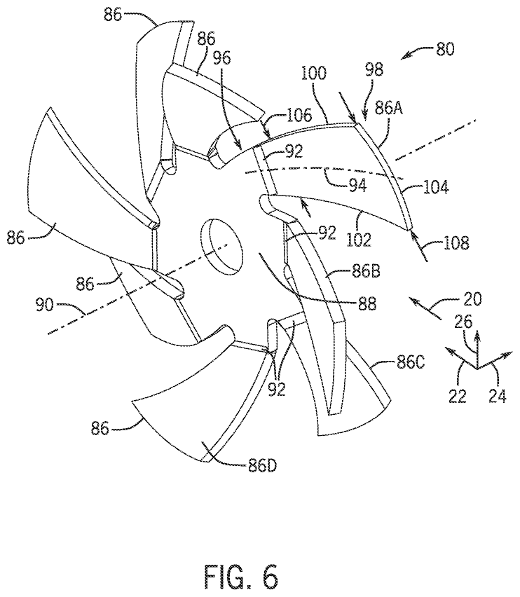

FIG. 6 is a perspective view of an embodiment of one of the chopper blades 80 that may be used in the agricultural implement 10 of FIG. 1. As shown, the chopper blade 80 includes the multiple fins 86 coupled to and circumferentially disposed about the hub 88 relative to the rotational axis 90. For example, the multiple fins 86 may include a first fin 86A, a second fin 86B, a third fin 86C, a fourth fin 86D, and so forth. In FIG. 6, the chopper blade 80 includes eight fins 86; however, it should be appreciated that the chopper blade 80 may include any suitable number of fins, such as 3, 4, 5, 6, 7, 8, 9, 10, or more.

Further, as shown, the fins 86 have a same geometry (e.g., size, shape) and are evenly spaced apart circumferentially about the hub 88. However, in certain embodiments, at least one of the fins 86 may have a different geometry (e.g., size, shape) from other ones of the fins 86. In FIG. 6, the fins 86 are positioned with a bend 92 relative to the hub 88 (extend laterally away from the hub 88). Further, adjacent fins 86 are positioned to have the bend 92 (e.g., extend laterally) in different, opposite directions relative to the axial axis 22. For example, the first fin 86A, the third fin 86C, and then every second fin 86 about the hub 88 may be considered to bend (e.g., extend laterally) in a first direction (e.g., left) relative to the hub 88. Additionally, the second fin 8B, the fourth fin 86D, and then every second fin 86 about the hub 88 may be considered to bend (e.g., extend laterally) in a second direction (e.g., right) relative to the hub 88. Thus, the fins 86 may be considered to include multiple sets of fins (e.g., a first sent that bends in the first direction, and a second set that bends in the second direction). Also as shown, the fins 86 are mounted or formed on the hub 88 at a compound angle with respect to the forward direction of travel 20. Thus, in addition to the bend 92, the fins 86 also generally curve or extend circumferentially from the hub 88. For example, in its illustrated position in FIG. 6, the first fin 86A generally curves or extends circumferentially toward the forward direction of travel 20, as shown by line 94.

In this way, the fins 86 are positioned to engage the soil, mix the soil, and toss the soil (e.g. upwardly, as well as left and right via the bends 92 in opposite directions; a “rooster tail” effect). The geometry of the fins 86 also assists with these operational effects. For example, the fins 86 are shaped like paddles and have an inner end portion 96, an outer end portion 98, a convex curved surface 100, a concave curved surface 102, and an outer surface 104. As shown, a respective width 106 of the inner end portion 96 is less than a respective width 108 of the outer end portion 98 (e.g., with the respective width 106 measured at a radially inner-most end at a connection to the hub 88 or radially outside of the bend 92 and with the respective width 108 measured at a radially outer-most end along the outer surface 104). The geometry of the fins 86 also enables pointed ends 110 to engage and toss the soil as the fins 86 roll in the forward direction of travel 20, as descried herein.

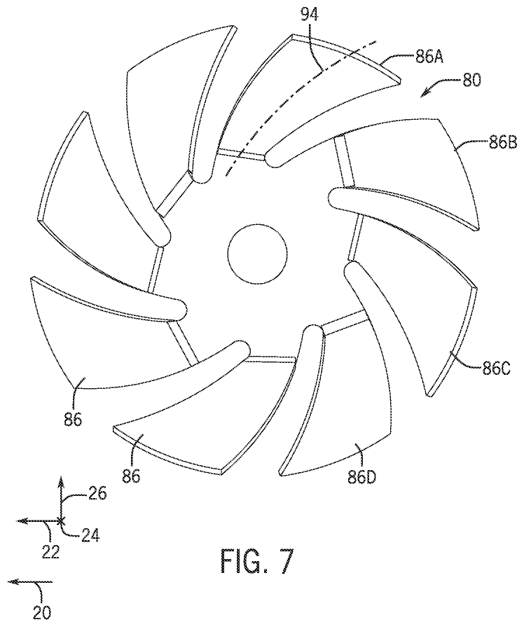

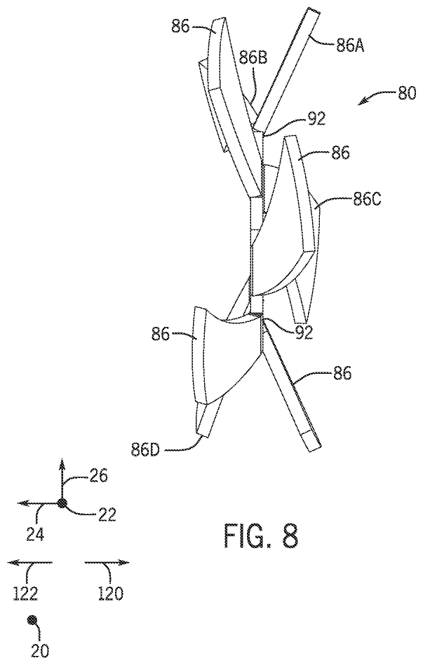

FIG. 7 is a side view of an embodiment of the chopper blade 80, and FIG. 8 is a front view of an embodiment of the chopper blade 80. In particular, FIGS. 7 and 8 provide additional views of the chopper blade 80 shown and described with reference to FIG. 6. As shown in FIGS. 7 and 8, the chopper blade 80 includes the multiple fins 86 coupled to and circumferentially disposed about the hub 88 relative to the rotational axis 90. For example, the multiple fins 86 may include the first fin 86A, the second fin 86B, the third fin 86C, the fourth fin 86D, and so forth.

Further, as shown in FIGS. 7 and 8, adjacent fins 86 are positioned to have the bend 92 (e.g., extend laterally) in different, opposite directions relative to the axial axis 22. For example, with reference to FIG. 8, the first fin 86A, the third fin 86C, and then every second fin 86 about the hub 88 may be considered to bend (e.g., extend laterally) in a first direction 120 (e.g., left) relative to the hub 88. Additionally, the second fin 8B, the fourth fin 86D, and then every second fin 86 about the hub 88 may be considered to bend (e.g., extend laterally) in a second direction 122 (e.g., right) relative to the hub 88. Also as shown in FIGS. 7 and 8, the fins 86 are mounted or formed on the hub 88 at the compound angle with respect to the forward direction of travel 20. Thus, in addition to the bend 92, the fins 86 also generally curve or extend circumferentially from the hub 88. For example, in its illustrated position in FIG. 7, the first fin 86A generally curves or extends circumferentially toward the forward direction of travel 20, as shown by line 94.

It should be appreciated that any features shown or described with reference to the figures may be combined in any suitable manner. While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A tilling implement, comprising:
a frame;
a row of disc blades coupled to the frame; and
a soil finisher coupled to the frame, wherein the soil finisher comprises a plurality of chopper blades, each chopper blade of the plurality of chopper blades comprises a plurality of fins that extend radially from a hub, a first set of the plurality of fins bend in a first direction relative to the hub, and a second set of the plurality of fins bend in a second direction relative to the hub to facilitate tossing soil as the tilling implement travels through a field.

2. The tilling implement of claim 1, wherein the first set of the plurality of fins bend laterally in the first direction relative to the hub, and the second set of the plurality of fins bend laterally in the second direction relative to the hub to facilitate tossing soil in the first direction and the second direction as the tilling implement travels through the field.

3. The tilling implement of claim 1, wherein each fin of the plurality of fins is positioned at a compound angle relative to the hub.

4. The tilling implement of claim 3, wherein the compound angle comprises a respective bend laterally relative to the hub, and a respective curve forward relative to the hub.

5. The tilling implement of claim 1, wherein each fin of the plurality of fins comprises a radially inner portion with a first width and a radially outer portion with a second width, and the first width is less than the second width.

6. The tilling implement of claim 1, wherein each fin of the plurality of fins comprises a convex curved surface and a concave curved surface that extend from a radially outer portion to a radially inner portion.

7. The tilling implement of claim 1, wherein the plurality of chopper blades are mounted on a shaft that extends laterally across at least a portion of the tilling implement.

8. The tilling implement of claim 7, wherein the plurality of chopper blades are mounted on the shaft to be rotationally offset relative to one another.

9. The tilling implement of claim 1, wherein the soil finisher is a rear-most ground-engaging structure of the tilling implement relative to a forward direction of travel.

10. The tilling implement of claim 1, wherein the plurality of chopper blades are configured to roll along the soil as the tilling implement travels through a field.

11. The tilling implement of claim 1, wherein the row of disc blades comprises pairs of solid disc blades.

12. A soil finisher for a tilling implement, the soil finisher comprising:
a frame;
a mounting bracket coupled to the frame;
a shaft coupled to the mounting bracket; and
a plurality of chopper blades disposed on the shaft, wherein each chopper blade of the plurality of chopper blades comprises a hub and a plurality of fins circumferentially disposed about the hub relative to a rotational axis of the hub, a first set of the plurality of fins bend laterally in a first direction relative to the hub, and a second set of the plurality of fins bend laterally in a second direction relative to the hub to facilitate tossing soil in the first direction and the second direction as the tilling implement travels through a field.

13. The soil finisher of claim 12, wherein each fin of the plurality of fins is positioned at a compound angle relative to the hub.

14. The soil finisher of claim 12, wherein each fin of the plurality of fins comprises a radially inner portion with a first width and a radially outer portion with a second width, and the first width is less than the second width.

15. The soil finisher of claim 12, wherein each fin of the plurality of fins comprises a convex curved surface and a concave curved surface that extend from a radially outer portion to a radially inner portion.

16. The soil finisher of claim 12, wherein the plurality of chopper blades are mounted on the shaft to be rotationally offset relative to one another.

17. The soil finisher of claim 12, wherein the soil finisher is configured to be a rear-most ground-engaging structure of the tilling implement relative to a forward direction of travel.

18. The soil finisher of claim 12, wherein the plurality of chopper blades are configured to roll along the soil as the tilling implement travels through the field.

19. An agricultural system, comprising:
a work vehicle; and
a tilling implement configured to couple to the work vehicle, wherein the tilling implement comprises:
a frame;
a row of disc blades coupled to the frame; and
a soil finisher coupled to the frame rearward of the row of disc blades relative to a forward direction of travel of the agricultural system, wherein the soil finisher comprises a plurality of chopper blades, each chopper blade of the plurality of chopper blades comprises a plurality of fins that extend radially from a hub, a first fin of the plurality of fins bends in a first direction relative to the hub, and a second fin of the plurality of fins bends in a second direction relative to the hub to facilitate tossing soil as the tilling implement travels through a field.

20. The agricultural system of claim 19, wherein each fin of the plurality of fins is positioned at a compound angle relative to the hub.
